(19) United States
(12) Patent Application Publication
(10) Pub. No.: US 2002/0012439 A1
(43) Pub. Date: Jan. 31, 2002

(54) Diaphragm-type bass loudspeaker

(75) Inventor: Norbert Schafer, Schontal (DE)

Correspondence Address: DARBY & DARBY P.C., 805 Third Avenue, New York, NY, 10022, US

(73) Assignee: JOACHIM ZURN

(21) Appl. No.: 09/886,622

(22) Filed: Jun. 21, 2001

Related U.S. Application Data
(63) Continuation of application No. PCT/DE99/04073, filed on Dec. 21, 1999.

(30) Foreign Application Priority Data
Dec. 21, 1998 (DE) 198 59 046.6

(51) Int. Cl. H04R 1/02; H04R 1/20

(52) U.S. Cl. 381/349; 381/332; 381/431

(57) ABSTRACT

A diaphragm-type bass loudspeaker has a housing (10), the housing walls (13, 14, 15) of which enclose a volume (25) which is formed on the rear side of its diaphragm (3). In a surface area of the housing walls (13, 14, 15) which bounds the volume (25) there is an opening (23).

The volume (25) is so small that the resonant frequency at which the oscillations of the amplifier correspond to the oscillations of the diaphragm (3) in terms of magnitude lies above 200 Hz (Hertz), in particular above 1000 Hz (Hertz), and is consequently in the frequency range of a mid-frequency or treble loudspeaker. At the same time, the opening (23) is formed such that, at every frequency of the diaphragm-type bass loudspeaker, air emerges from the volume at a great velocity.

The invention relates to a diaphragm-type bass loudspeaker for the conversion of electric signals into acoustic signals.

In particular, the invention relates to a diaphragm-type bass loudspeaker with a converter of electrical oscillations into mechanical oscillations connected to a diaphragm, which converts the mechanical oscillations into sound.

In the case of a known diaphragm-type bass loudspeaker frequently used in practice, with a generator of electromagnetic oscillations connected to a diaphragm which converts the electromagnetic oscillations into sound, the housing is a closed airtight box, with the aid of which the rearwardly emitted wave front of the diaphragm is hindered from meeting the wave front emitted at the front side of the diaphragm. In the case of these closed housings, the air in the housing retards the forward and rearward movement of the diaphragm, causing the resonant frequency of the loudspeaker system to increase. The smaller the volume of air of a closed housing, the higher the spring action of the enclosed air and consequently the higher the resonant frequency.

An unfavourable aspect of the known diaphragm-type bass loudspeaker is that it is only possible with large diaphragms to produce good sound or good reproduction over a large frequency range, and in particular in the range of very low frequencies, i.e. in the bass range, since only with these large diaphragms is it possible to reproduce low-pitched tones. However, if the large diaphragm is fitted in a relatively small housing, low-pitched tones are not emitted, because the air cushion on the rear side of the diaphragm retards the movement of the diaphragm. For this reason, the housing of the diaphragm-type bass loudspeaker must be chosen to be of a very large volume. However, if loudspeakers are sold in the consumer sector and used by final consumers, the maximum size of the loudspeakers is limited.

Another known diaphragm-type bass loudspeaker has a basic loudspeaker body which is surrounded by a closed housing which contains pressure equalizing openings on its rear side (DE 19601217 C1, EP-0456416 A2) . These openings reduce the rigidity of the air cushion of the diaphragm and, by the pressure equalization, facilitate the work of the diaphragm, so that the housings can be chosen somewhat smaller for good reproduction than in the case of completely closed housings. However, in the case of these diaphragm-type bass loudspeakers, low-pitched tones are not emitted, since in the range of low frequencies the opening opposes the rearward sound with an air resistance which is too small. For this reason, the system operates in the lower frequency range as if there were no housing present, i.e. the rearward sound eliminates the sound on the front side of the diaphragm in the range of these low-pitched tones.

In the case of another known diaphragm-type bass loudspeaker, the sound emitted at the rear side of the diaphragm is not eliminated but is partially rendered usable. An exactly defined opening in the housing connected to tunnels or ducts or a passive diaphragm allows the rearward sound to pass to the outside. The opening acts as a pure pressure equalizing opening or, in certain frequency ranges, as a sound amplifier. The rearward sound no longer eliminates the sound on the front side in certain frequency ranges but instead amplifies it. This utilizes the effect that not only objects capable of oscillating but also air-filled cavities have a resonance. This cavity resonance can be influenced by changing the volume of the housing or changing the sound-permeable opening or the passive diaphragm. The rearward sound passes more intensely to the outside and, together with the sound from the front side of the diaphragm, produces a high sound emission.

In the case of these diaphragm-type bass loudspeakers, an optimum effect is only achieved, however, when the housing volume, resonant frequency of the diaphragm in the housing and the dimensions of the reflex opening or of the passive diaphragm are matched very precisely to one another. There remains the disadvantageous aspect that low-pitched tones cannot be emitted in the case of these diaphragm-type bass loudspeakers either, since in the range of low-pitched frequencies the opening does not oppose the rearward sound with any air resistance, or only with a small air resistance. This in turn leads to the pressure waves of the air corresponding to the low-pitched frequencies being able to pass unhindered through the opening. For this reason, this system operates in the lower frequency range as if no housing were present, i.e. the rearward sound produced behind the diaphragm eliminates the sound produced in front of the diaphragm in the range of these low-pitched tones.

Music or tones in general are a mixture of various frequencies. Therefore, with every loudspeaker the aim is to reproduce these tones as faithfully as possible. A precondition for this is that all the currently played frequencies are reproduced purely harmonically and at the correct volume.

Known diaphragm-type bass loudspeakers are particularly efficient in their resonant range. In the case of resonance, the oscillations of the amplifier, i.e. the oscillations of the forcing system and the oscillations of the coil, and consequently of the diaphragm, are in phase when there is normal excursion. The amplifier and the restoring force of the diaphragm act in the same direction. The range around the resonant frequency is consequently reproduced very loudly. The resonant frequency of the known diaphragm-type bass loudspeakers lies in the operating range of the loudspeaker, and consequently between 15 Hz and 200 Hz. A faithful reproduction of tones in the range of the resonant frequency is consequently not possible without additional means. To control the resonant range, it is known to attempt to monitor this resonant range with sophisticated electronic aids. Sensors and circuits which detect and report the position of the diaphragm are used, so that the volume of the resonant frequency range can be regulated by suitable electronic control circuits. Known sensors are capacitive or inductive displacement transducers or light barriers, entered for example by a wedge attached to the diaphragm.

A disadvantageous aspect of conventional diaphragm-type bass loudspeakers has been found to be that sophisticated amplifier technology is necessary to activate the loudspeaker. Seen from the amplifier, these loudspeakers form a very strongly inductive impedance with an effective component and a reactive component. As a result, the impedance fluctuates over the range of reproduction between about 2 and 80 Ω. In addition, the loudspeaker acts as a voltage generator which emits negative field voltages to the amplifier, acting in phase opposition to the voltage of the amplifier. For this reason, electronically very sophisticated technology is necessary for the amplifier in order to compensate in an approximate way for voltage and resistance fluctuations of the loudspeaker.

The object of the invention is to provide a diaphragm-type bass loudspeaker which is as good as possible.

This object is achieved by designing the diaphragm-type bass loudspeaker presented at the beginning in such a way that the rearward sound is transformed into undisturbing noise, which is quieter by a factor of approximately 100, by means of a very small opening in the basic body of the loudspeaker. Furthermore, according to the invention, the basic body or the housing of the loudspeaker is kept small, in order to make the resonant frequency correspondingly high.

The diaphragm-type bass loudspeaker according to the invention as claimed in claim 1 has the advantage that the tones of the bass range, in particular between 30 Hz and the lower audible limit of 16 Hz, are not eliminated but are reproduced as purely harmonic tones. Since the resonant frequency lies entirely outside the operating range of the loudspeaker, loudspeaker distortion, such as that which is unavoidable in the prior art in the range of the resonant frequency, is ruled out. The resonant frequency, located in the range of the mid-frequency or treble tone, makes it possible to transmit the entire bass range in a virtually error-free manner in accordance with the feeding electric signal.

The basic body, acting as a very small housing, reduces the size of the air cushion on the rear side of the diaphragm. This advantageously causes the resonant frequency of the system to be increased. It is particularly favourable to choose the size of the basic body such that, although the resonant frequency still lies in the transmission range of the system, it is above the operating range. It is also advantageous to pass the sound from the rear side of the diaphragm directly to the small opening in the basic body or the housing, which acts in relation to the diaphragm emitting useful sound as a very small diaphragm. Consequently, the sound pressure of the diaphragm emitting the desired useful sound with a very small excursion is transformed at the small, rear opening into noise, which leaves the opening with great excursion and a great rate of motion and manifests itself as an acoustically undisturbing stream of air. It has been found that the volume of this air leaving the opening is smaller by a factor of approximately 100 than the volume of the useful sound of the diaphragm. Furthermore, it has proven to be particularly favourable to choose the depth of the opening to be so small that there is no volume air in it, or only a negligible amount, which does not oppose the sound pressure at the opening with any appreciable air resistance. To generate harmonic waves, it has proven to be particularly favourable to determine a minimum cross section for the surface-area reducing opening.

The diaphragm-type bass loudspeaker according to the invention, in which the resonant frequency has been taken out of the operating range, has the effect that monitoring of the resonant range is advantageously not required. This dispenses with the need for sophisticated electronic monitoring circuits.

Furthermore, the diaphragm-type bass loudspeaker according to the invention is characterized in that it represents a linear impedance without any appreciable deviation for the upstream amplifier over the entire operating range. The amplification is real, virtually without any imaginary component, since the impedance of the coil has an effect only above the operating range, i.e. the loudspeaker approximately represents a purely resistive load for the amplifier. As a result, greatly simplified amplifier technology is possible, since it is possible to dispense with electronically very sophisticated technology to compensate for voltage and resistance fluctuations.

In a further preferred embodiment of the diaphragm-type bass loudspeaker, an open basic body which is fitted into a small housing is used. In this case, the opening is integrated into the housing. The mode of operation of this embodiment of the diaphragm-type bass loudspeaker otherwise corresponds to that mentioned above. To simplify the structural design of the diaphragm-type bass loudspeaker with housing, the opening may be formed by a bezel gap. The bezel preferably consists of metal, but a simple-to-fabricate injection moulding of plastic or other suitable materials may also be produced, and is connected to the housing for example by screwing, clamping etc. It is particularly advantageous that this design makes a fine adjustment possible if need be after the diaphragm-type bass loudspeaker has been assembled. The bezel makes it possible to keep the depth of the opening as small as desired.

According to a further embodiment, the opening may be formed as, for example, a hole or slit in a perforated plate, for example a thin-walled perforated plate.

Furthermore, a further configuration of the diaphragm-type bass loudspeaker envisages providing this opening as an opening in the housing or basic body which becomes smaller in a conical or step-shaped manner from inside to outside, has a large surface area on the inner side of the housing and opens into an opening with a very small surface area towards the outside.

The efficiency of the diaphragm-type bass loudspeaker can be set by a layer of insulating material in front of the rear wall of the loudspeaker. The loudspeaker can be produced particularly easily in technical production terms if at the end of assembly the housing is closed by an angle piece with a leg ending in the form of a bezel, which makes the opening. The layer of insulating material may fill the entire rear region in the housing in front of the opening. However, it is also possible to arrange insulating material in front of the opening and/or on the rear wall of the housing.

To increase the efficiency of the diaphragm-type bass loudspeaker, it has also proven to be favourable to increase the surface area of the diaphragm of the loudspeaker. It has been found that this is achieved most advantageously in design terms by combining a number of loudspeakers, and consequently a number of diaphragms, together in one block. An exemplary embodiment of this is provided in the drawing.

The invention is explained in more detail as described below on the basis of exemplary embodiments represented in the drawing, in which:

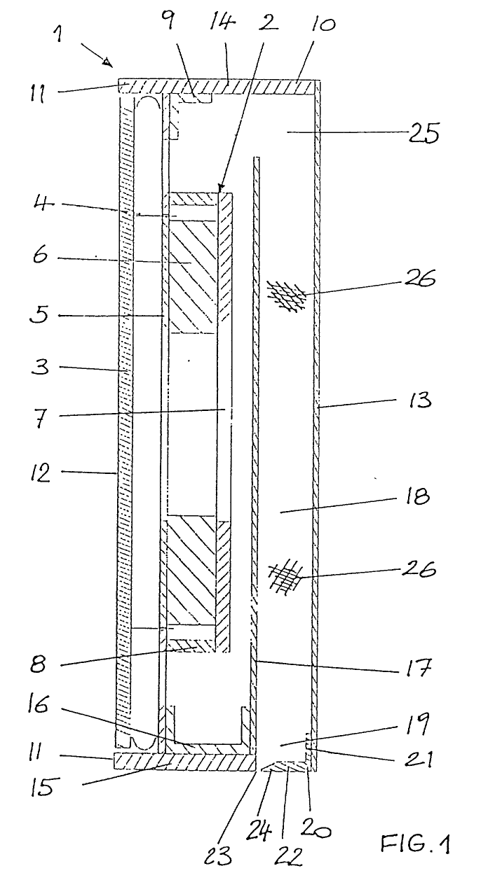

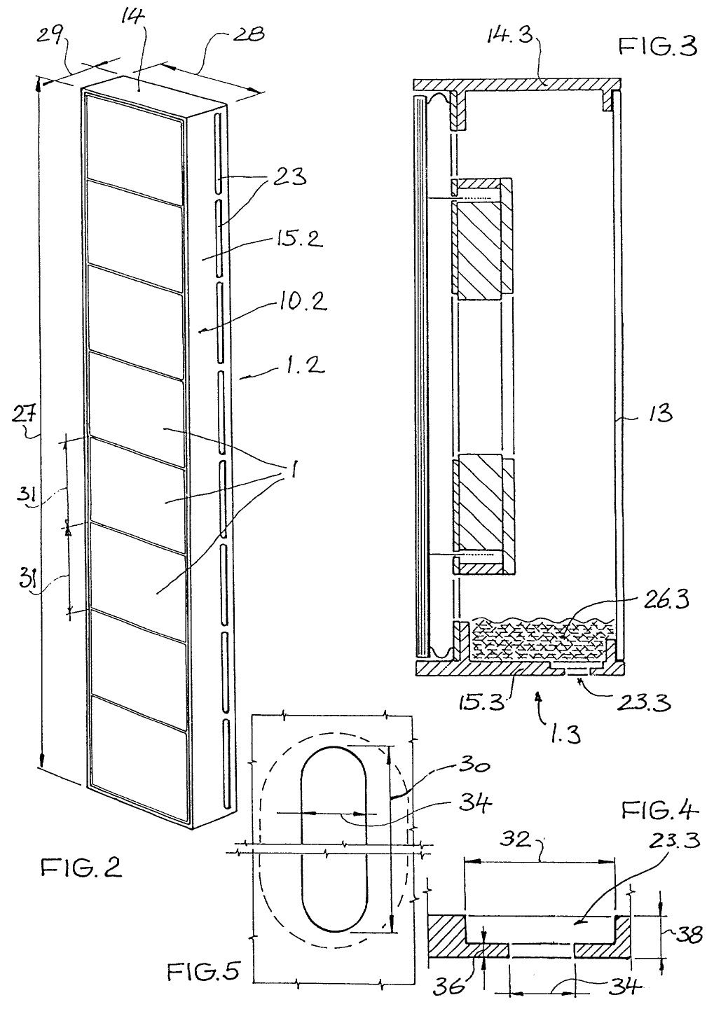

FIG. 1 shows a sectional drawing through a first embodiment of a diaphragm-type bass loudspeaker according to the invention,

FIG. 2 shows a perspective view of a second embodiment of the invention, with a block comprising eight assembled diaphragm-type bass loudspeakers according to FIG. 1,

FIG. 3 shows a representation similar to that of FIG. 1 for a further embodiment of a diaphragm-type bass loudspeaker according to the invention,

FIG. 4 shows a sectional representation through the opening present in the housing according to FIG. 3 and

FIG. 5 shows a view of the opening according to FIGS. 2, 3.

The diaphragm-type bass loudspeaker 1 has a housing-like basic body 2 and a very flexibly suspended plate diaphragm 3, which lies on the front side of the latter and is operated by an oscillation drive 4 lying on the rear side of said diaphragm. Provided on the rear side of the base plate 5, opposite it, without any contact, is a permanent magnet 6. Fastened to the rear side of the permanent magnet 6 is a bottom plate 7, the periphery of which is greater than the outer periphery of the permanent magnet 6. Arranged between the above bottom plate 7 and the base plate 5 as a magnetic flux conductor around the magnet 6 is an annular or rectangular surround 8. A housing 10 is fastened to the base plate 5 by connection parts 9, 16 in such a way that its front edges 11 terminate in a plane with the front side 12 of the plate diaphragm 3 or protrude slightly beyond it.

On the rear side of the loudspeaker, the housing side walls 14, 15 together with the rear wall 13 of the loudspeaker enclose a relatively small volume 25. In this case, the side wall 15 is shortened to the rear with respect to the three other sides 14. On the shortened side wall 15, a U-shaped connection part 16, by which the side wall 15 is fastened to the base plate 5 on one side, is used on the other side to connect a dividing wall 17, which protrudes into a large region of the housing 10, into the interior space taken up by the volume 25. A space 18 between the dividing wall 17 and the rear wall 13 of the loudspeaker is filled with insulating material 26.

At the outwardly open end 19 of this space region 18, an angle piece 20 is fastened in a suitable way, for example by adhesive bonding, by one of its two legs 21 to the rear wall 13. The second leg 22 of the angle piece 20 closes the housing 10 apart from a small gap 23, which forms an opening, the leg 22 running out on its inner side towards the opening 23 in a long, flat bevel 24. When there are oscillating motions of the diaphragm 3, the air on its rear side is blown out at a great velocity through the very small surface area of the bezel gap 23 in relation to the surface area of the diaphragm.

Represented in FIG. 2 is a diaphragm-type bass loudspeaker 1.2 which is made up of eight loudspeakers as shown in FIG. 1 in a block. Of its basic body 10.2, the upper side wall 14 and the side wall 15.2 can be seen. The side wall 15.2 is made up of eight side walls 15 as shown in FIG. 1. In the side wall 15.2 there are eight slits 23, in accordance with the number of individual loudspeakers 1. The diaphragm-type bass loudspeaker 1.2 has a height 27 of 1692 mm (millimeters), a width 28 of 222 mm and a depth 29 of preferably between 30 and 100 mm, in the present case of 70 mm. Apart from the surrounding housing edges (front edges 11 according to FIG. 1), the surface area of the diaphragm accounts for 97% (per cent) of the front side of the diaphragm-type bass loudspeaker 1.2. This front side of the loudspeaker, which represents the baffle of the loudspeaker, comprises the loudspeaker chassis in its entirety.

In the case of the diaphragm-type bass loudspeaker 1.3 represented in FIG. 3, there is no dividing wall as there is in FIG. 1. In the case of this embodiment, insulating material 26.3 is arranged only in front of the gap-shaped opening 23.3 tapering outwards in a stepped manner. Insulating material 26 or 26.3 may also be arranged on the inner side of the rear wall 13 and on the side wall 14.3 lying opposite the opening 23.3. In the case of the embodiment of the diaphragm-type bass loudspeaker 1.3, angle-shaped or U-shaped connection parts 9, 16 according to FIG. 1 have been replaced by correspondingly profiled side walls 15.3, 14.3.

The opening 23.3 has a length 30 of slightly less than 210 mm. 210 mm is the system dimension 31 of the individual loudspeaker 1 in the loudspeaker 1.2 made up of eight loudspeakers in a block. In this way, the individual slit-shaped openings 23.3 in the case of the present example are not in contact with one another. The inside width 32 of the stepped opening 23.3 in the case of the present example is 18 mm. The front, externally visible width 34 of this opening 23.3 is between 5 and 15 mm, in the case of the present example 8 mm. The front step thickness 36 is 2 mm. The side wall 15.3 has a total thickness 38 of 5 mm. Such a thin side wall, consisting of aluminium in the case of the present example, is possible in the case of the diaphragm-type bass loudspeaker 1, 1.2, 1.3, since the natural resonant frequencies lie above the operating frequencies of the bass loudspeaker.

1. Diaphragm-type bass loudspeaker,
comprising a housing (10), the housing walls (13, 14, 15) of which enclose a volume (25) which is formed on the rear side of the diaphragm (3),
and comprising at least one opening (23) in a surface area of the housing walls (13, 14, 15) which bounds the volume (25),
wherein
the volume (25) is so small that the resonant frequency of the diaphragm-type bass loudspeaker at which the amplifier and the restoring force of the diaphragm (3) act in the same direction lies above 200 Hz (Hertz), and is consequently in the frequency range of a mid-frequency or treble loudspeaker, and
the opening (23) is formed such that, it is very small, so that at every frequency of the diaphragm-type bass loudspeaker, air emerges from the volume at a great velocity which is acoustically undisturbing.

2. Diaphragm-type bass loudspeaker (1) according to claim 1, wherein the housing of the diaphragm-type bass loudspeaker (1) is formed by the basic body (2) of the diaphragm-type bass loudspeaker (1).

3. Diaphragm-type bass loudspeaker (1) according to claim 1, wherein the housing (10) which encloses the volume (25) contains the basic body of the diaphragm-type bass loudspeaker (1).

4. Diaphragm-type bass loudspeaker (1) according to claim 1, wherein the opening (23) is a slit.

5. Diaphragm-type bass loudspeaker (1) according to claim 1, wherein the opening (23) is formed by a gap or bezel gap becoming smaller towards the outside in a step-shaped or conical manner.

6. Diaphragm-type bass loudspeaker (1) according to claim 1, wherein the opening (23) is located in a very thin-walled housing part.

7. Diaphragm-type bass loudspeaker (1) according to claim 6, wherein the thin-walled housing part is an aluminium plate.

8. Diaphragm-type bass loudspeaker (1) according to claim 1, wherein the opening (23) comprises a conically running bore which has a large radius on the inner side of the housing part and opens out towards the outside in an aperture with a very small radius.

9. Diaphragm-type bass loudspeaker (1) according to claim 1, wherein at least the housing part (20) which makes the opening (23) is produced from metal.

10. Diaphragm-type bass loudspeaker according to claim 1, wherein a number of diaphragm-type bass loudspeakers (1.1) are assembled into a block.

11. Diaphragm-type bass loudspeaker (1.2) according to claim 10, wherein the block has a single housing (10.2).

12. Diaphragm-type bass loudspeaker according to claim 10, wherein the block has a depth (30) of 30 to 100 mm.

13. Diaphragm-type bass loudspeaker according to claim 10, wherein eight diaphragm-type bass loudspeakers (1.1) are assembled into a block.

14. Diaphragm-type bass loudspeaker according to claim 13, wherein the block of eight diaphragm-type bass loudspeakers (1.1) has a height (27) of approximately 1692 mm, a width (28) of approximately 222 mm and a depth (29) of approximately 70 mm.

15. Diaphragm-type bass loudspeaker (1; 1.2) according to claim 1, wherein there is insulating material (26; 26.3) in the volume (25; 25.3), and at least in front of the opening (23; 23.3) there.
